(19) United States
(12) Patent Application Publication
(10) Pub. No.: US 2005/0096446 A1
(43) Pub. Date: May 5, 2005

(54) Tri-block copolymers and a process for the preparation of the same

(75) Inventors: Mohan Gopalkrishna Kulkarni, Pune (IN); Jayant Jagannath Khandare, Pune (IN)

Correspondence Address: MERCHANT & GOULD PC, P.O. BOX 2903, MINNEAPOLIS, MN, 55402-0903, US

(73) Assignee: COUNCIL OF SCIENTIFIC AND INDUSTRIAL, New Delhi (IN)

(21) Appl. No.: 10/697,970

(22) Filed: Oct. 29, 2003

(51) Int. Cl. C08F 118/02

(52) U.S. Cl. 526/319

(57) ABSTRACT

The present invention relates to tri-block copolymers of molecular weight ranging between 2,000 Daltons to 2,00,000 Daltons having formula (1), having extraordinarily high binding strength, 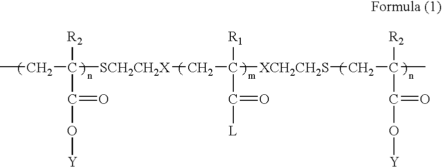 wherein,
R₁ is H, CH₃, C₂H₅, or C₆H₅; R₂ is H, CH₃, C₂H₅, or C₆H₅; X is an ester or amide linkage; m is ranging from 3 to 500; n is ranging from 2 to 50; L is OH, NH₂, OCH₃, or NHCH(CH₃)₂; Y is N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose, or amylose, a simple and effective process for the preparation of the tri-block copolymers of formula (1), and a method of preventing and/or treating microbial infections, wherein the said method comprises steps of exposing the microbe to the tri-block copolymer of formula 1, and thereafter, binding of the polymer to the microbe inhibits the microbial infection.

### FIELD OF THE PRESENT INVENTION

The present invention relates to tri-block copolymers of molecular weight ranging between 2,000 Daltons to 2,00,000 Daltons having formula (1), having extraordinarily high binding strength, 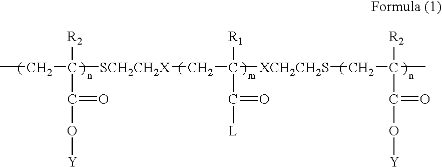
wherein,
R₁ is H, CH₃, C₂H₅, or C₆H₅; R₂ is H, CH₃, C₂H₅, or C₆H₅, here, R₂ at aforementioned two positions can be either identical or different; X is an ester or amide linkage; m is ranging from 3 to 500; n is ranging from 2 to 50; L is OH, NH₂, OCH₃, or NHCH(CH₃)₂; Y is N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose, or amylose, a simple and effective process for the preparation of the tri-block copolymers of formula (1), and a method of preventing and/or treating microbial infections, wherein the said method comprises steps of exposing the microbe to the tri-block copolymer of formula 1, and thereafter, binding of the polymer to the microbe inhibits the microbial infection.

### BACKGROUND OF THE PRESENT INVENTION

Many biological events involve multivalent binding of the ligands to the host receptors. Carbohydrates have ability to interact with proteins and lead to many biological important events such as cell adhesion, cell recognition, immunoassay and fertilization. The importance of carbohydrates in biologically-relevant recognition processes has recently come to light. (Feizi et al., Biochem. J. 245:1,1987).

Belvilacqua et al., (Science 243:1160,1989) demonstrated carbohydrates along with proteins and nucleic acids, act as primary biological information carriers. Rouhi, A. M., (Chem. Engg. News, September 23, 62-66,1996) reported critical role of carbohydrates in various biological processes such as cell recognition, cell adhesion, cell differentiation, inflammation, viral and bacterial infection, tumerigenesis, and metastasis.

Various targets for carbohydrate such as enzymes, proteins and viruses are identified which can have numerous applications in therapeutics. Sharon et al., (Science 246:227-234,1989) suggested carbohydrate portions of glyco-conjugate molecules to be an important entity in biology.

Few of the major advantage of carbohydrate modification may be that it can impart change in physical characteristics such as solubility, stability, activity, antibody recognition and susceptibility to enzyme. Carbohydrates can be incorporated in polymer chain and can be utilized for binding to the receptors. Thereby, the polymers can be coupled with the other polymers containing ligand for multivalent effect.

Preparation of hydrophilic polymers by coupling the carbohydrate portion to the hydrophilic polymer portion was demonstrated by Stahl, et al. (U.S. Pat. No. 6,037,467, 2000).

Recent patent granted to Mandeville et al. (U.S. Pat. No. 5,891,862, 1999 and U.S. Pat. No. 6,187,762, 2001) reported the use of polyvalent polymers containing carbohydrates for the treatment of rotavirus infection. Krepinsky et al (U.S. Pat. No. 6,184,368, 2001) suggests the application of carbohydrates in preventing the infections.

Most of the natural interactions, especially carbohydrate interaction are considered to be of low affinity. Monovalent ligands display weak affinities and poor specificity towards the receptor binding sites and therefore there is a necessity to prepare multivalent ligands for enhanced binding. The resultant saccharide in a multivalent form can bind to the same substrate with greater affinity and specificity. The binding of cell surface receptors to multivalent carbohydrate molecules exhibits wide variety of biological responses and has unique edge over monovalent interactions (Mammen et al. Angew. Chem., Int. Ed., 37,2754-2794,1998).

Multivalent interactions are characterized by the simultaneous binding between the multiple ligands on one entity and multiple receptors on another.

Multivalent moieties can be prepared with recognition of binding host sites, moreover they can be structured with molecular flexibility and orientation around the host. The characteristics of multivalent interactions are different than their monovalent counterparts as the latter involve one to one binding whereas multivalent interaction involves simultaneous binding of ligands at multiple sites of host molecules.

Polymers comprising multiple ligands could be more effective inhibitors for the host cell receptor, as a result of higher affinity for the pathogen. In addition the higher molecular weight of the polymeric ligands also prevents the infection through steric exclusion. (Spaltenstein, A., and Whitesides, G. M., J. Am. Chem. Soc., 113,686,687,1991). Laura Kiessling and Nicola L Pohl reported (Chemistry & Biology, 3:71-77, 1996) newer structural templates for the generation of multivalent carbohydrates containing multivalent saccharide derivatives useful for biological recognition events.

There is a need to devise simple methodology to obtain multivalent ligands of varying polymolecularity. Agglutination of erythrocytes caused by influenza virus can be prevented by use of polyvalent sialic acid inhibitors. This novel approach which is a model for pathogen-host interactions was reported by Mammen, M., and Whitesides, G., M. (J. Med. Chem. 38:21,4179-90,1995). The authors reported polymers containing sialic acid as effective inhibitors of influenza virus. Moreover, they suggested two favorable mechanisms for inhibition between the surfaces of virus and erythrocytes 1) High-affinity binding through polyvalency, and 2) Steric stabilization. Sigal et al. (J. Am. Chem. Soc., 118:16, 3789-3800,1996) studied the efficacy of polymers containing sialoside groups in inhibiting the adhesion of influenza virus to erythrocytes. They delineated the contributions of enhanced substrate ligand binding and steric considerations to efficiency of inhibition. These investigators reported sialic acid ligands, which can be exploited for the inhibition of the influenza virus. Monomeric inhibitor requires a higher concentration for inhibition since they are required to occupy at least half of the sialic acid binding sites on the virus, whereas the high molecular weight inhibitors need only a few attachments to achieve the same.

Various methods have been reported in the past to synthesize multivalent ligands such as ring-opening metathesis polymerization (ROMP). ROMP has been used to generate well defined, biologically active polymers by Gibson et al., (Chem. Comm., 1095-1096,1997) and Biagini et al., (Polymer, 39, 1007-1014, 1998).

Many researchers in the past have reported the synthesis and evaluation of sialoside-containing polyacrylamide inhibitors of the influenza virus. Whitesides and coworkers Mammen, M., Dahmann, G. & Whitesides, G. M. (J. Med. Chem. 38, 4179-4190,1995) demonstrated effective inhibitors of hemagglutination by influenza virus synthesized from polymers comprising active ester groups. They used a broad range of sialic acid substituted acrylamide copolymers to probe the mechanism of inhibition of hemagglutination by multivalent carbohydrates.

An understanding of the mode of action of the polyvalent sialosides provides a method for the design of inhibitors for influenza virus and insights into the mechanisms through which natural polyvalent ligands might act.

Polymers reported earlier are mostly based on carbohydrate-conjugation to the polyacrylamide backbone. Alternative polymers in the backbone may be more effective than such polymers. The effect of methods for synthesis of the saccharide-modified materials on their inhibition efficiency may be attributed to the density of functional groups.

Ring-opening metathesis polymerization (ROMP) methods have been applied for the synthesis of carbohydrate-substituted materials (Mortell, K. H., Gingras, M. & Kiessling, L. L. (J. Am. Chem. Soc. 116, 12053-12054, 1994). Like acrylamide polymerization, ROMP can be used in polar solvents and the carbohydrate residues need not be protected. Jason E. Gestwicki, Laura E. Strong, Christopher W. Cairo, L., Frederick J. Boehm, and Laura L. Kiessling, Chemistry & Biology, Vol. 9, 163-169, 2002, demonstrated the use of polymers generated by ring-opening metathesis polymerization (ROMP) as scaffolds to noncovalently assemble multiple copies of a lectin, the tetravalent protein concanavalin A (Con A).

The synergetic application of stimuli-responsive polymers and interactive molecules to form site-specific conjugates useful in variety of assays, separations, processing, and other uses are disclosed by Hoffman; A. S.; Patrick, S. (U.S. Pat. No. 5,998,588, 1999). The interactive molecules used can be biomolecules such as polysaccharides or glycoproteins, proteins or peptides, as antibodies, receptors, or enzymes, which specifically bind to ligands in the suitable environment. The inventors prepared stimuli-responsive polymers coupled to the recognition biomolecules at a specific site so that the polymer can be manipulated by stimulation to alter ligand-biomolecule binding at an adjacent binding site, for example, the biotin binding site of streptavidin, the antigen-binding site of an antibody or the active, substrate-binding site of an enzyme. Ligand which is conjugated to polymers binds to active site of biomolecule must also be evicted from the binding site with change in environment. Such polymer conjugates find application in selective phase separation or affinity precipitation of biomolecules. The polymers used for such applications can be stimuli-responsive to an appropriate environmental stimulus.

Multidentate saccharide-substituted ligands do exhibit increased avidity and specificity in protein carbohydrate recognition processes. Kiessling, L. L.; Pohl, N. L. Chem. & Biol. 1996, 3, 71-77) reported the binding of multivalent ligands to cell surface receptors that lead to a biological responses, multivalent interactions are different than by monovalent interactions.

Thus, methods of synthesizing tri-block copolymers with defined multivalent ligands for enhanced interactions provide a means for exploring biologically important processes.

In general, high binding epitope density results in greater numbers of receptors bound per polymer, faster rates of clustering, and reduced inter-receptor distances. Ligands with low binding epitope density, are the most efficient on a binding epitope. Moreover results provide insight into the design of ligands for controlling receptor-receptor interactions which mimic mechanisms by which natural multivalent ligands bind to the substrates.

Damschroder et al. (U.S. Pat. No. 2,548,520,1951) disclosed high molecular weight materials prepared by copolymerizing proteins conjugated with unsaturated monomers or proteins conjugated with preformed polymers. Synthesis of these high molecular weight materials generally requires temperatures up to 100° C. Such high temperatures are not well tolerated by most of the proteins. Thus the methods described are unsuitable for producing polymers of biologically active molecules.

The carbohydrate such as NAG serve as ligands for lectins and lysozyme. Roy et al. (J. Chem. Soc. Chem. Comm., 1611-1613,1992) reported custom designed glycopolymer synthesis by terpolymerizations. The N-acryloyl precursors and the acrylamide were used as effector molecules to provide specific properties such as hydrophobicity and mimicking tyrosine residues of proteins.

Mochalova et al. (Antiviral Research, 23,179-190, 1994) reported carbohydrate inhibitors like sialic acid anchored to polymeric or liposomal carriers. They conjugated glycylamido benzylsialoside with poly (acrylic acid-co-acrylamides) and dextrans. These polymeric ligands were evaluated for their ability to bind influenza A and B virus strains in cell culture.

Dimick et al. (J. Am. Chem. Soc., 121,44,10286,1999) explored newer strategies based on enhancing interactions. Synthesis of polyvalent ligands was reported and the role of glycosidic clusters in enhancing binding with plant lectin concanavalin A was demonstrated.

In an alternative approach Kanai, et al. (J. Am. Chem. Soc., 119, 9931-9932,1997) reported ring opening metathesis polymerization (ROMP) consisting multivalent mannose binding to concanavalin A. However the methods are complicated and do not control “living” nature of glycopolymer.

Yamada et al. (Macromolecules, 32,3553-3558,1999) reported controlled synthesis of amphiphilic block co polymers with pendant N-Acetyl Glucosamine (NAG) residues by living cationic polymerization. Copolymer architecture resulted in an enhancement in binding between Wheat Germ Agglutinin (WGA) and NAG.

Krepinsky, et al. (U.S. Pat. No. 6,184,368,2001) reported methods for synthesis of polyvalent carbohydrate molecules by glycosylation of partially protected polysaccharides bearing a single glycosylating agent or a mixture of glycosylating agents. The patent explains the non-productive binding of chitosan to lysozyme. Chitosan (Formula 4) is linear, binary heteropolysaccharide and consists of 2-acetaamido-2-deoxy-β-D-glucose (GlcNAc; A-unit) and 2-amino-2-deoxy-β-D-glucose (GlcNAc, D-unit). The active site of lysozyme comprises subsites designated A-F. Specific binding of chitosan sequences to lysozyme begins with binding of the NAG units in the subsite C. Moreover natural ligands derived from glucose are susceptible to microbial growth. There is need to synthesize ligands similar to repeat units of chitosan which will not be hydrolyzed by lysozyme. These polymers are expected to be more stable than chitin and chitosan.

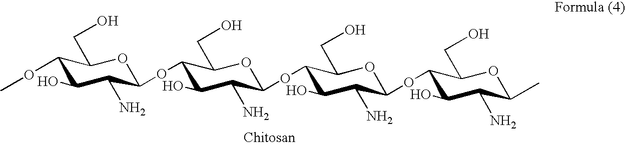

Apart from the type of the ligand, its distribution along the polymer chain also plays a crucial role in influencing the efficiency of the inhibition.

The present invention provides tri-block copolymers for a biomolecular target and method for synthesis thereof, which exhibits selective binding to the target enzyme.

### OBJECTS OF THE PRESENT INVENTION

The main objective of the present work is to synthesize tri-block copolymers containing polyvalent ligand for enhanced interactions with the substrates.

Another main objective of the present invention is to provide a simple and novel process for the preparation of tri-block copolymers comprising polyvalent NAG, which exhibit multivalent interactions. The merits of the approach have been highlighted using NAG as an illustration.

Another object of the present invention is to provide tri-block copolymers containing NAG which are more effective in binding with the lysozyme as evidenced by the values of the binding constants K_{b} and relative inhibition of lysozyme more effectively as evaluated by the values of I₅₀.

Yet another object of the present invention is to provide tri-block copolymers for applications in medicine and biotechnology.

Yet another object of the present invention is to provide a convenient method of preparation of tri-block copolymers containing polyvalent ligand NAG, mannose, galactose or sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose and amylose.

Still another object of the present invention is to provide a convenient method of preparation tri-block copolymers containing Acryloyl, Methacryloyl or Para Vinyl Benzoyl (PVB) moieties.

Yet another object of the present invention is to provide a convenient method of incorporation of polyvalent conjugates varying in molecular weights.

Yet another object of the present invention is to provide a convenient method of preparation of tri-block copolymers of varying molecular weight and varying polyvalent ligands.

Yet another object is to provide a method of preparation of tri-block copolymers containing NAG ligands for enhanced interactions.

Still another object is to provide more stable ligands for the interactions with biomolecules than the natural polymers such as chitin and chitosan containing natural ligand NAG.

### SUMMARY OF THE PRESENT INVENTION

The present invention relates to tri-block copolymers of molecular weight ranging between 2,000 Daltons to 2,00,000 Daltons having formula (1), having extraordinarily high binding strength, 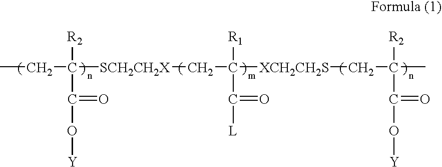
wherein,
R₁ is H, CH₃, C₂H₅, or C₆H₅; R₂ is H, CH₃, C₂H₅, or C₆H₅, here, R₂ at aforementioned two positions can be either identical or different; X is an ester or amide linkage; m is ranging from 3 to 500; n is ranging from 2 to 50; L is OH, NH₂, OCH₃, or NHCH(CH₃)₂; Y is N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose, or amylose, a simple and effective process for the preparation of the tri-block copolymers of formula (1), and a method of preventing and/or treating microbial infections, wherein the said method comprises steps of exposing the microbe to the tri-block copolymer of formula 1, and thereafter, binding of the polymer to the microbe inhibits the microbial infection.

### DETAILED DESCRIPTION OF THE PRESENT INVENTION

Accordingly, the present invention relates to tri-block copolymers of molecular weight ranging between 2,000 Daltons to 2,00,000 Daltons having formula (1), having extraordinarily high binding strength, 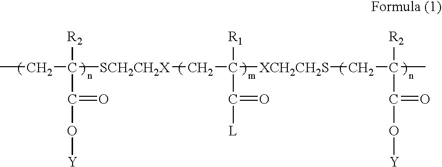
wherein,
R₁ is H, CH₃, C₂H₅, or C₆H₅; R₂ is H, CH₃, C₂H₅, or C₆H₅ here, R₂ at aforementioned two positions can be either identical or different; X is an ester or amide linkage; m is ranging from 3 to 500; n is ranging from 2 to 50; L is OH, NH₂, OCH₃, or NHCH(CH₃)₂; Y is N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose, or amylose, a simple and effective process for the preparation of the tri-block copolymers of formula (1), and a method of preventing and/or treating microbial infections, wherein the said method comprises steps of exposing the microbe to the tri-block copolymer of formula 1, and thereafter, binding of the polymer to the microbe inhibits the microbial infection.

In an embodiment of the present invention, wherein tri-block copolymers of molecular weight ranging between 2,000 Daltons to 2,00,000 Daltons having formula (1), having extraordinarily high binding strength, 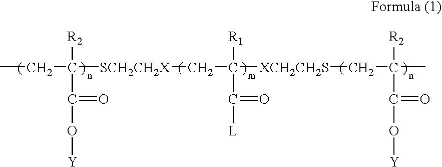
wherein,
R₁ is H, CH₃, C₂H₅, or C₆H₅; R₂ is H, CH₃, C₂H₅, or C₆H₅, here, R₂ at aforementioned two positions can be either identical or different. X is an ester or amide linkage; m is ranging from 3 to 500; n is ranging from 2 to 50; L is OH, NH₂, OCH₃, or NHCH(CH₃)₂; Y is N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose, or amylose.

In another embodiment of the present invention, wherein the tri-block co-polymer as claimed in claim 1, wherein the co-polymer is stable, and usable.

In yet another embodiment of the present invention, wherein the said co-polymer shows about 11,000 times increase in the binding strength as compared to the ligand alone.

In another main embodiment of the present invention, wherein a simple and effective process for the preparation of tri-block copolymers of formula 1, said process comprises steps of:
dissolving the polymer of formula 3 bearing di functional groups at both terminal ends in a solvent,
adding a polyvalent oligomer of formula 2 into the dissolved polymer of step (a) in the ratio of about 1:2 for di-functional group to polyvalent oligomer to obtain a reaction mixture,
dissolving a coupling agent to the reaction mixture in the ratio of about 1:1 to initiate the reaction,
allowing a reaction for a time duration ranging between 24 hrs to 48 hrs at room temperature ranging between 15 to 45° C.,
removing the unreacted coupling agent after the reaction by filtration to obtain tri-block polymer,
precipitating the tri-block polymer in a non-solvent at room temperature ranging between 15 to 45° C. to obtain the dried tri-block copolymers.

In still another embodiment of the present invention, wherein A process as claimed in claim 4, wherein the polymers bearing di functional groups at both ends is selected from a group comprising acrylic acid, methacrylic acid, methacryloyl chloride, acrylamide, N-isopropyl acrylamide (NIPA), 2-acrylamido-2-methyl propanesulphonic acid (AMPS) methacrylate, acryloyl chloride, acryloyl morpholine, vinyl pyrrolidone, styrene, allyl alcohol, and allyl amine.

In still another embodiment of the present invention, wherein the polymers bearing di functional groups at both ends contain COOH group.

In still another embodiment of the present invention, wherein the polyvalent oligomer containing terminal reactive group ligands is selected from a group comprising polymethacryloyl NAG, polyacryloyl NAG, and Poly vinyl benzyl NAG.

In an embodiment of the present invention, wherein the oligomer containing terminal reactive group contain OH or NH₂ group.

In an embodiment of the present invention, wherein the organic solvent is selected from a group comprising dimethyl formamide, tetra hydro furan, and di-methyl sulfoxide. In an embodiment of the present invention, wherein the coupling agent used is selected from a group comprising compounds Di Cyclohexyl Carbodiimide (DCC), 1-Cyclohexyl 3-(2-Morpholinoethyl) Carbodiimide metho-p-toluenesulfonate (CMC), and 1-Ethyl-3-(3-Dimethylamino-propyl) Carbodiimide (EDC).

In an embodiment of the present invention, wherein the molar ratio of coupling agent to polymer is about 1:1.

In an embodiment of the present invention, wherein the non-solvent is selected from a group comprising acetone, diethyl ether, hot water, and hexane.

In an embodiment of the present invention, wherein a method of preventing and/or treating microbial infections, wherein the said method comprises steps of exposing the microbe to the tri-block copolymer of formula 1, and thereafter, binding of the polymer to the microbe inhibits the microbial infection.

In yet another embodiment of the present invention, wherein the possibility of drug resistance does not exist.

In still another embodiment of the present invention, wherein the said method helps prevent and or treat infection caused by influenza virus, wheat germ agglutinin and rotavirus.

In an embodiment of the present invention, wherein the % increase in the relative inhibition of the microbe (Iₘₐₓ) is about 60%.

In an embodiment of the present invention, wherein the said co-polymer shows about 11,000 times increase in the binding strength as compared to the ligand alone.

This invention relates to tri-block copolymers containing N-Acetyl Glucosamine (NAG) of molecular weight ranging from 2,000 Daltons to 2,00,000 Daltons having formula (1) 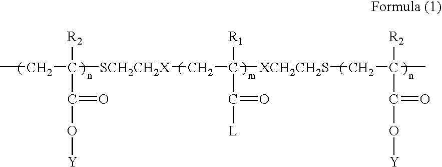
wherein,
R₁ is H, CH₃, C₂H₅, C₆H₅, R₂ is H, CH₃, C₂H₅, C₆H₅, here, R₂ at aforementioned two positions can be either identical or different, X is an ester or amide linkage, m is from 3 to 500, n is from 2 to 50, L is OH, NH₂ and NHCH(CH₃)₂. Y may be N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose and amylose.

More particularly it relates to the said BAB tri-block copolymers containing carbohydrate ligands and preparation thereof.

Still more particularly it relates to tri-block copolymers, which bind more strongly to lysozyme than NAG itself.

The tri-block copolymers of the present invention as mentioned above are prepared by coupling oligomers bearing terminal reactive group of formula (2) claimed and prepared as per procedure given herein below 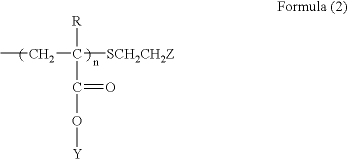
wherein, R is H, CH₃, C₂H₅, C₆H₅, n is from 2 to 50, Z is OH or NH₂ group.

Y may be N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose and amylose; with polymers bearing di functional groups at terminal as given below (Formula 3) 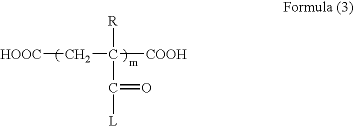
wherein,
L is OH, NH₂, OCH₃, NHCH(CH₃)₂, R is H, CH₃, C₂H₅, C₆H₅, m is from 3 to 500.

The tri-block copolymers may be used for inhibition of viral infections and the recoveries of biomolecules. The approach of preparation of tri-block polymers containing polyvalent ligand N-Acetyl Glucosamine(NAG) is generic and can be used for other ligands such as sialic acid, galactose and mannose.

The present invention also provides a method for obtaining affinity ligand useful for isolating bio-molecule from a solution. In the process tri-block copolymers reported here contain varied chain length of reactive polymer coupled to another reactive polymer containing polyvalent ligands. Thus, tri-block polymers demonstrate greater binding constants and inhibition concentration even at very low ligand concentration. The polymers reported here are tri-block copolymers with suitable molecular weights which offer wide range of polymer architecture than those realized in the past. Moreover, tri-block polymeric ligands containing N-Acetyl Glucosamine reported here are easy to prepare and are resistant to degradation, reusable, stable and free from microbial contamination.

The present invention relates to tri-block copolymers for applications in medicine and biotechnology and synthesis thereof. Tri-block copolymers comprise polyvalent N-Acetyl Glucosamine (NAG), which bind more efficiently to lysozyme than NAG alone. The effective inhibition is possible even at very low ligand concentrations than reported in the past. Tri-block copolymers could be used for prevention and treatment of bacterial and viral infections. Moreover, these polymers can be stimuli sensitive and used for the recovery of biomolecules. The methodology of preparation of tri-block copolymers reported here can be extended to other polymers and ligands such as sialic acid and used for preventing influenza and/or rotavirus infections. It also provides a method for preparation of tri-block copolymers wherein polymers comprising sequences of specific ligands are essential.

The present invention relates to tri-block copolymers containing carbohydrate ligands and preparation thereof. The polymers bearing terminal functional group are coupled with polymers containing functional polyvalent NAG.

The tri-block copolymers comprising carbohydrate may also further be used in the treatment of bacterial or viral infections, and are expected not to cause drug resistance. Tri-block BAB copolymers containing NAG show enhanced hydrolytic stability and water solubility than natural polymers containing NAG such as chitosan and chitin. They may be also used as anti infective agents both for prevention and treatment of diseases, recovery of the naturally occurring as well as genetically manipulated biomolecules.

The approach described herein is a generic one and can be extended to other systems as well. For example sialic acid ligands are known to bind to influenza and rotavirus. Hence polymers comprising sialic acid can be expected to bind to these viruses and others containing similar receptor sites more strongly than the corresponding monomers, oligomers and macromers and copolymers. Moreover, the tri-block copolymer exhibit enhanced interactions even with decreased incorporation of NAG. The enhanced interaction between the polymer conjugate with a specific binding site of biomolecule also finds applications in affinity separations, drug delivery and biotechnology.

Design of high affinity protein carbohydrate binding systems can provide an alternative strategy for the treatment of infectious diseases e.g. influenza and rotavirus. This has the advantage as such agents will not have pathogen resistance to antibiotics and drugs. A new approach to treat influenza is based on the principle of inhibition of virus to the host cells. The inhibitors like sialic acid anchored to polymeric or liposomal carriers have been reported in the past.

The present invention comprise BAB tri-block copolymers containing polyvalent NAG. The tri-block copolymers reported here will always result in formation of NAG sequences in juxtaposition with one another which will exhibit more pronounced inhibition than random copolymers containing the same concentration of the ligand. We have further demonstrated that block copolymers containing NAG units as oligomers, bind to lysozyme more strongly as evidenced by values of K_{b} and inhibit lysozyme more efficiently as evidenced by values of 150. There is tremendous enhancement in interactions for BAB tri-block copolymers although the NAG concentration is very small which also indicates the steric stabilization effect.

Tri-block copolymers of varied length and density will be useful for receptor ligand interactions of biological origin. Various chemical and chemoenzymatic methods have been reported in the past for the preparation of di- and trivalent ligands, dendrimers, and high molecular weight polymers but have proven to be complicated to synthesize. Thus, there is necessity of a simple methodology to obtain tri-block copolymers with multivalent ligands.

We have shown that the oligomers of NAG in which the NAG groups are juxtaposed to one another, bind more effectively to lysozyme as reflected in values of binding constant (K_{b}) and the inhibition concentrations I₅₀. Moreover, we have also demonstrated in the conventional technique of free radical copolymerization the distribution of monomers along the polymer chain depends upon the values of the monomer reactivity ratios which are determined primarily by the intrinsic structure of the monomer. Consequently the distribution of the NAG units in the copolymers comprising monomers bearing NAG cannot be tailored at will using conventional copolymerization techniques.

To overcome this problem we have devised a novel strategy to ensure that the tri-block copolymers prepared using conventional condensation polymerization technique which will always contain sequences of NAG units as desired.

The present invention provides tri-block copolymers containing NAG bearing oligomers for a biomolecular target and method for preparation thereof.

The approach described here to prepare tri-block copolymers containing polyvalent NAG ligands is simple and can be used to synthesize other polyvalent ligands such as sialic acid, which bind to influenza virus and rotavirus. Such ligands may also be used as ant infective agents both for prevention and treatment of diseases. Moreover, functional oligomeric NAG can be anchored to thermo precipitating polymers that can be used for the recovery of biomolecules such as lysozyme and lectins.

The present invention relates to the tri-block copolymers for application in the recovery of biomolecules.

The tri-block copolymers comprising polyvalent ligands may further be used in the treatment of bacterial or viral infections, and are expected not to cause drug resistance.

The approach described herein is a generic one and can be extended to other systems as well for example sialic acid.

The present invention provides methods for the preparation for tri-block copolymers containing N-Acetyl Glucosamine (NAG). These tri-block copolymers provide improved binding and inhibition of biomolecules. Moreover, tri-block copolymers can be stimuli sensitive polymers which can be used for the biomolecule recoveries. The method of preparation of tri-block copolymers can be applied to other ligands such as sialic acid galactose and mannose.

The present invention relates to the tri-block copolymers containing NAG for applications in medicine and biotechnology.

Polysaccharides and polyacrylics polymers are water insoluble and are being used in the biochemistry, affinity chromatography and immunoassays as solid-phase supports with passively adsorbed or covalently linked antibodies.

It is possible to prepare either water-soluble or water-insoluble polymers by changing the chemical composition of the monomers which may impart various chemical and physical-properties. e.g. water-soluble monomers such as N-isopropyl acrylamide (NIPA) may be homopolymerized to form water-soluble homopolymers.

A further aspect of the present invention is to prepare tri-block copolymers comprising a polyvalent carbohydrate ligands.

Another aspect of the present invention is to use tri-block copolymers containing NAG for enhanced interactions with biomolecules.

The term “tri-block copolymer” means any polymer prepared by coupling functional polyvalent polymers either as BAB tri-block polymers, using acrylic or methacrylic acid, acryloyl or methacryloyl chloride, glycidyl acrylate or methacrylate, glycerol acrylate or methacrylate, allyl chloride; hydroxy-lower-alkyl-acrylates, such as 2-hydroxyethyl methacrylate or 3-hydroxypropyl methacrylate, and amino-lower-alkylacrylates, such as 2-amino-ethyl methacrylate to polyvalent ligands such as NAG, sialic acid or mannose and may contain spacer arm. Monomers, which are soluble in water or water/polar organic solvent mixtures, are particularly preferred.

A “polyvalent ligand” means any polymer containing ligands N-Acetyl Glucosamine, mannose, galactose and sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose and amylose. Polyvalent ligands are soluble in water or water/polar organic solvent mixtures are preferred.

NAG is derived from chitosan which is a linear, binary heteropolysaccharide and consists 2-acetaamido-2-deoxy-β-D-glucose (GlcNAc; A-unit) and 2-amino 2-deoxy-β-D-glucose (GlcNAc, D-unit). Chitosan is a powerful natural ligand, which binds to lysozyme through the NAG residues. But it suffers from three major limitations) Chitosan is insoluble at neutral pH, which limits many applications. 2) Chitosan undergoes the transglycosylation and mutarotation, which substantially reduces its activity and efficiency 3) Chitosan is hydrolyzed by lysozyme.

Accordingly the present invention provides a tri-block copolymer of molecular weight ranging from 2,000 Daltons to 2,00,000 Daltons having formula (1) 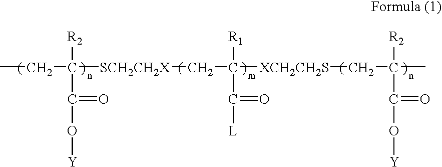
wherein,
R₁ is H, CH₃, C₂H₅, C₆H₅, R₂ is H, CH₃, C₂H₅, C₆H₅, here, R₂ at aforementioned two positions can be either identical or different X is an ester or amide linkage, m is from 3 to 500, n is from 2 to 50, L is OH, NH₂, OCH₃ and NHCH(CH₃)₂
Y may be N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose and amylose.

The present invention also provides a simple and novel process for the preparation of tri-block copolymers as mentioned above which comprises dissolving the polymer bearing di functional groups at both terminals in a solvent, adding to this a polyvalent oligomer, dissolving a coupling agent to this reaction mixture, allowing a reaction for a period of 24 hrs to 48 hrs at a room temperature ranging between 15 to 45° C., removing the unreacted coupling agent by filtration, precipitating in a non solvent and vacuum drying at room temperature to obtain the tri-block copolymer.

In another embodiment of the present invention the polymers bearing di functional groups at both terminal ends may be acrylic acid, methacrylic acid, methacryloyl chloride, acrylamide, N-isopropyl acrylamide (NIPA), 2-acrlamido-2-methyl propanesulphonic acid (AMPS) methacrylate, acryloyl chloride, acryloyl morpholine, vinyl pyrrolidone and styrene.

In still another embodiment of the present invention the polymer bearing di functional groups at both terminal ends may be polymethacryloyl NAG or polyacryloyl NAG or Poly vinyl benzyl NAG.

In yet another embodiment of the present invention polymers bearing di functional groups at both ends may contain COOH or OH.

In still another embodiment of the present invention the polyvalent oligomer containing terminal reactive group ligands may be polymethacryloyl NAG or polyacryloyl NAG or Poly vinyl benzyl NAG.

In still another embodiment the oligomer containing terminal reactive group may contain OH or NH₂.

In still another embodiment the organic solvent used to dissolve the polymer containing terminal reactive group and oligomer containing terminal reactive group may be dimethyl formamide, tetra hydro furan or di-methyl sulfoxide.

In yet another embodiment the coupling agent used may be selected from compounds such as Di Cyclohexyl Carbodiimide (DCC), 1-Cyclohexyl 3-(2-Morpholinoethyl) Carbodiimide metho-p-toluenesulfonate (CMC), 1-Ethyl-3-(3-Dimethylamino-propyl) Carbodiimide (EDC).

In yet another embodiment the molar ratio of coupling agent for condensation of polymers may be 1:1.

In yet another embodiment the non solvent used to precipitate the tri-block copolymers may be acetone, diethyl ether, hot water or hexane.

In yet another embodiment of the present invention the tri-block copolymerization may be carried out at room temperature ranging between 15 to 45° C.

In a feature of the present invention the tri-block copolymers containing ligand may be useful for applications in medicine and biotechnology.

In yet another feature of the present invention provides more stable tri-block copolymers for the interactions with biomolecules than the natural polymers such as chitin and chitosan containing N-Acetyl Glucosamine.

In yet another feature of the present invention tri-block copolymers containing polyvalent NAG are more efficient than copolymers of identical NAG content in the form of monomers, as evidenced by higher values of K_{b} and lower values of I₅₀.

In yet another feature of the present invention tri-block copolymers containing ligands reported here can bind simultaneously on to the multiple sites of the enzyme/disease causing virus thereby enhancing the inhibitory effect.

In yet another feature of the present invention tri-block copolymers containing polyvalent ligand provides greater accessibility to the ligand conjugate for binding with receptor biomolecule.

In yet another feature the method used for estimation of the relative inhibition may be in terms of I₅₀ mM and Iₘₐₓ mM values.

In yet another feature of the present invention tri-block copolymers containing ligands reported herein are effective at very low concentration, which is advantage when the ligand under consideration are expensive e.g. sialic acid.

In yet another feature of the present invention tri-block copolymers containing ligands reported here containing NAG are stable, water soluble, resistant to degradation, and free from microbial contamination which is an advantage over the natural polymers such as chitin and chitosan.

It is also expected that the presence of multiple ligands in the polymer backbone will enhance binding to the virus and biomolecules such as influenza virus, rotavirus, wheat germ agglutinin. The multiblock copolymers containing multiple ligands can potentially interact with multiple receptors simultaneously thereby enhancing the binding to lysozyme.

Previous methods of synthesis of copolymers and block co polymers are complicated, moreover there are few reports available on method of incorporation of polyvalent ligands in such block copolymers.

It is also reported that the polymeric fucosides are resistant to neuraminidase enzyme present on the surface of influenza virus. The viruses cleave sialic acid groups from molecules that bind to the surface of the virus, and thereby destroy the binding ability.

The tri-block copolymers reported here may need lower incorporation of polyvalent ligand than reported in the past. Moreover they are effective at very low concentration which is a significant advantage when the ligands under consideration are expensive e.g. sialic acid. The process reported here for the incorporation of polyvalent ligands into multiblock copolymers is relatively simple and involves lesser steps.

The ability of tri-block copolymers to bind virus and biomolecules provides a means of developing new therapeutic agents. These tri-block polymers can be used in various applications such as affinity separations and immunoassays.

The tri-block copolymers are of suitable molecular weights, which can efficiently bind to the target site.

The ligands on tri-block copolymers have ability to bind to various substrate molecules simultaneously. It is expected that the presence of multiple ligands in the backbone can enhance binding to the viruses and biomolecules.

The process for the preparation of the tri-block copolymers the present invention with reference to examples which are illustrative only and should not be considered to limit the scope of the present invention in any manner.

### EXAMPLE 1

This example describes the process for the preparation of P (N-Iso Propyl Acrylamide (PNIPA) bearing di carboxyl groups at terminals.

2.4 gm (0.0211 M) NIPA was dissolved in 25 ml of isobutyl alcohol in a two neck round bottom flask and was stirred to make a solution. The resultant solution was Nitrogen purged and polymerization was initiated by addition of 2 mg of 4,4 Azobis (4-Cyanovaleric acid) at 55° C. for 12 hrs. The polymer was precipitated in diethyl ether and vacuum dried at room temperature ranging between 15 to 45° C.

### EXAMPLE 2

This example describes the process for the preparation of tri block copolymers of di carboxyl Poly N-Iso Propyl Acrylamide with Poly Acryloyl N-Acetyl Glucosamine (P.Ac.NAG.OH) bearing terminal hydroxyl groups.

3.5 gm of carboxyl terminated Poly N-Iso Propyl Acrylamide and 0.5 gm of hydroxyl terminated Poly Acryloyl N-Acetyl Glucosamine (P.Ac.NAG) was dissolved in 25 ml dimethylformamide (DMF) in a round conical flask. This was stirred continuously to obtain a clear solution and 2 gm dicyclohexyl carbodiimide (DCC) was added. The reaction was carried out at room temperature for 48 hrs. DCU was filtered off, the polymer was precipitated in diethyl ether and vacuum dried at room temperature.

Table 2. demonstrates tri-block polymers of varying block lengths of P.NIPA and P. Ac.NAG

### EXAMPLE 3

This example describes estimation of binding constant (K_{b}) of tri-block copolymers containing NAG by fluorescence spectrophotometric method.

Fluorescence spectra of lysozyme were recorded on a Perkin Elmer LS-50 B luminescence spectrophotometer. Excitation frequency was 285 nm. Solutions of lysozyme and tri-block copolymers containing N-Acetyl Glucosamine were prepared in 0.066 M phosphate buffer pH 6.2, containing 0.0154 M sodium chloride and 0.008 M sodium azide. 0.1 milliliter of lysozyme 80 μg/ml was mixed with solution containing different ligand concentration in a 2 ml capacity 10 mm square quartz cells maintained at 18° C.

Phosphate buffer was added to make the volume to 2 ml. The fluorescence intensities of the solutions were measured, relative to the solutions containing enzymes and buffer mixtures of the identical concentrations reference. The relative fluorescence intensity of lysozyme saturated with solution containing different tri-block ligand concentration, F∝, was extrapolated from the experimental values by plotting 1/(Fₒ−F) against 1/[S] where F is the measured fluorescence of a solution containing enzyme with given substrate concentration [S] and Fₒ is the fluorescence of a solution of enzyme alone (Chipman et al., J. Biol. Chem., 242-19, 4388-4394,1967). The highest concentration of polymer substrates was used when enzyme was saturated more than 85%.

TABLE 1
Binding Constants (K_{b}) for Tri-block B-A-B Copolymers

| Mole % NAG | Mol. wt A | Mol. wt B | K_{b} | LCST |
|---|---|---|---|---|
| 0.72 | 36000 | 638 | 3.98 × 10⁶ | 32.7 |
| 0.46 | 56000 | 638 | 4.36 × 10⁶ | 32.7 |
| 0.29 | 90000 | 638 | 4.96 × 10⁶ | 32.7 |

Binding constants for tri-block BAB tri-block copolymers are summarized in Table I wherein, tri-block copolymer of molecular weight 90000-638 has binding constant 4.96×10⁶ which show 10,564 folds enhancement to NAG (5.24×10 2).

### EXAMPLE 4

Estimation of binding of lysozyme by tri-block copolymers containing NAG.

Relative binding of tri-block copolymers containing NAG was estimated by using a procedure reported by Neuberger and Wilson (1967).

1.5% w/v stock solutions of tri-block polymeric ligands was prepared in 0.0066 M phosphate buffer pH 6.2 containing 0.0154 m sodium chloride and 0.008 M sodium azide. One milliliter of stock solution containing different ligand concentration was mixed with 1.6 ml of 78 μg/ml of Micrococcus lysodeikticus in a 3-ml capacity glass cuvette. The mixture was incubated for 5 minutes at 20° C. To this mixture 0.1 ml of lysozyme (27 μg/ml) was added and mixed thoroughly. The absorbance at 450 nm (Δ_{A450}) was recorded for 30 seconds. A blank reading without the polymer ligand was noted and the change in the absorbance per second was calculated. Then relative inhibition was calculated.

TABLE 2
Estimation of Relative Inhibition of Lysozyme by Tri-block BAB
Copolymers Containing NAG

| Mole % | Mol. wt | Mol. wt | | Iₘₐₓ | |
|---|---|---|---|---|---|
| NAG | A | B | I₅₀ mM | % | Iₘₐₓ mM |
| 0.72 | 36000 | 638 | 0.00035 | 50.00 | 0.00035 |
| 0.46 | 56000 | 638 | 0.00022 | 64.11 | 0.00022 |
| 0.29 | 90000 | 638 | 0.000085 | 83.33 | 0.00141 |

The relative inhibition of lysozyme in terms of 150 for monomer NAG is 74.00 mM and has decreased to 0.000085 mM for 90000-638 block co polymer, which is almost 900000 times lower than that for NAG.

The Iₘₐₓ has increased from 55.29 mM to 83.33%.

Block copolymers sequences follow one another along the main polymer chain. The various possibilities of sequence of the polymer chain in block copolymers are known in the art. A person skilled in the art can easily design the various possible sequences on the basis of aforementioned information.

The Advantages of the Present Invention are as Follows:

The tri-block copolymers reported here comprise polyvalent ligands for enhanced interactions.
1. The tri-block copolymers have higher molecular weight and demonstrate greater efficiency through steric exclusion.
2. The tri-block copolymers have greater water solubility, stability, and susceptibility to enzyme from hydrolysis.
3. The enhancement in binding due to polyvalent interactions arise from the conformational flexibility of tri-block copolymers with the biological receptors.
4. The method of preparation of tri-block copolymers always give juxtaposition polyvalent sequences of NAG ligands and can bind to two lysozyme simultaneously.
5. The tri-block copolymers containing polyvalent NAG are effective even at low ligand concentration than monomer itself.
6. The tri-block copolymers are thermoprecipitating polymers and make them suitable for biomolecule recovery.
7. The tri-block copolymers can bind simultaneously to multiple binding sites of biomolecules thereby demonstrates enhanced interactions.
8. The methodology of preparation of tri-block copolymers reported here can be extended to other polymers and ligands such as sialic acid and used for preventing influenza and/or rotavirus infections.

1. Tri-block copolymers of molecular weight ranging between 2,000 Daltons to 2,00,000 Daltons having formula (1), having extraordinarily high binding strength, 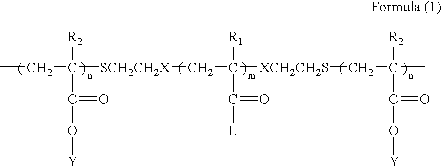
wherein,
R₁ is H, CH₃, C₂H₅, or C₆H₅; R₂ is H, CH₃, C₂H₅, or C₆H₅; here, R₂ at aforementioned two positions can be either identical or different; X is an ester or amide linkage; m is ranging from 3 to 500; n is ranging from 2 to 50; L is OH, NH₂, OCH₃, or NHCH(CH₃)₂; Y is N-Acetyl Glucosamine, mannose, galactose, sialic acid, fructose, ribulose, erythrolose, xylulose, psicose, sorbose, tagatose, glucopyranose, fructofuranose, deoxyribose, galactosamine, sucrose, lactose, isomaltose, maltose, cellobiose, cellulose, or amylose.

2. The tri-block co-polymer as claimed in claim 1, wherein the co-polymer is stable, and usable.

3. The tri-block co-polymer as claimed in claim 1, wherein the said co-polymer shows about 11,000 times increase in the binding strength as compared to the ligand alone.

4. A simple and effective process for the preparation of tri-block copolymers of formula (1) of claim 1, said process comprises steps of:
a. dissolving the polymer of formula 3 bearing di-functional groups at both terminal ends in a solvent,
b. adding a polyvalent oligomer of formula 2 into the dissolved polymer of step (a) in the ratio of about 1:2 for di-functional group to polyvalent oligomer to obtain a reaction mixture,
c. dissolving a coupling agent to the reaction mixture in the ratio of about 1:1 to initiate the reaction,
d. allowing a reaction for a time duration ranging between 24 hrs to 48 hrs at room temperature ranging between 15 to 45° C.,
e. removing the unreacted coupling agent after the reaction by filtration to obtain tri-block polymer,
f. precipitating the tri-block polymer in a non-solvent at room temperature to obtain the dried tri-block copolymers.

5. A process as claimed in claim 4, wherein the polymers bearing di functional groups at both ends is selected from a group comprising acrylic acid, methacrylic acid, methacryloyl chloride, acrylamide, N-isopropyl acrylamide (NIPA), 2-acrylamido-2-methyl propanesulphonic acid (AMPS) methacrylate, acryloyl chloride, acryloyl morpholine, vinyl pyrrolidone, styrene, allyl alcohol, and allyl amine.

6. A process as claimed in claim 4, wherein the polymers bearing di functional groups at both ends contain COOH group.

7. A process as claimed in claim 4, wherein the polyvalent oligomer containing terminal reactive group ligands is selected from a group comprising polymethacryloyl NAG, polyacryloyl NAG, and Poly vinyl benzyl NAG.

8. A process as claimed in claim 4, wherein the oligomer containing terminal reactive group contain OH or NH₂ group.

9. A process as claimed in claim 4, wherein the organic solvent is selected from a group comprising dimethyl formamide, tetra hydro furan, and di-methyl sulfoxide.

10. A process as claimed in claim 4, wherein the coupling agent used is selected from a group comprising compounds Di Cyclohexyl Carbodiimide (DCC), 1-Cyclohexyl 3-(2-Morpholinoethyl) Carbodiimide metho-p-toluenesulfonate (CMC), and 1-Ethyl-3-(3-Dimethylamino-propyl) Carbodiimide (EDC).

11. A process as claimed in claim 4, wherein the molar ratio of coupling agent to polymer is about 1:1.

12. A process as claimed in claim 4, wherein the non-solvent is selected from a group comprising acetone, diethyl ether, hot water, and hexane.

13. A method of preventing and/or treating microbial infections, wherein the said method comprises steps of exposing the microbe to the pharmaceutically effective amount of tri-block copolymer of formula 1, and thereafter, binding of the polymer to the microbe inhibits the microbial infection.

14. A method of treatment as claimed in claim 13, wherein the possibility of drug resistance does not exist.

15. A method of treatment as claimed in claim 13, wherein the said method helps prevent and or treat infection caused by influenza virus, wheat germ agglutinin and rotavirus.

16. A method of treatment as claimed in claim 13, wherein the % increase in the relative inhibition of the microbe (Iₘₐₓ) is about 60%.

17. A method of treatment as claimed in claim 13, wherein the said co-polymer shows about 11,000 times increase in the binding strength as compared to the ligand alone.
